(19) United States
(12) Patent Application Publication
(10) Pub. No.: US 2012/0115608 A1
(43) Pub. Date: May 10, 2012

(54) METHOD AND APPARATUS FOR CONTROLLING AN AUDIO PARAMETER OF A PLURALITY OF WAGERING GAME MACHINES

(76) Inventors: Howard Pfeifer, Chicago, IL (US); Steve Zoloto, Highland Park, IL (US)

(21) Appl. No.: 12/940,967

(22) Filed: Nov. 5, 2010

(51) Int. Cl. A63F 13/00

(52) U.S. Cl. 463/35

(57) ABSTRACT

Apparatus, systems, and methods may operate to choreograph an audio presentation among a plurality of wagering game machines, the wagering game machines initially being configured by respective users to play audio at respective user-selected volumes. A shared game is triggered among the plurality of wagering game machines and during the shared game, the plurality of wagering game machines are adjusted to play audio at a specified common volume instead of the respective user-selected volumes. At or after a conclusion of the shared game, the plurality of wagering game machines are adjusted to play audio at the respective previously-configured user-selected volumes.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2010, WMS Gaming, Inc. All rights reserved.

### FIELD

Embodiments of the inventive subject matter relate generally to wagering game systems, and more particularly to methods and apparatus for controlling an audio parameter of a plurality of wagering game machines.

### BACKGROUND

Wagering game machines, such as slot machines, video poker machines, and the like, have been a cornerstone of the gaming industry for many years. Generally, the popularity of such machines depends on the likelihood (or perceived likelihood) of winning money at the machine, and the intrinsic entertainment value of the machine relative to other available gaming options. Where the available gaming options include a number of competing machines and the expectation of winning at each machine is roughly the same (or believed to be the same), players are most likely attracted to what they see as the most entertaining and exciting of the machines. Consequently, shrewd operators strive to employ the most entertaining and exciting machines available because such machines attract frequent play and increase profitability for the operator.

To provide increased entertainment value, some wagering game machines are arranged in a bank or in some other organized proximity to one another, and are configured to, at some point in time, collaboratively participate in a shared wagering game. The shared wagering game may involve engaging multiple players to enter a shared game, where the shared game may be either the base (or sole) game or a secondary game.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating a wagering game machine according to embodiments of the invention;

FIG. 2 is a perspective view of a wagering game machine, according to embodiments of the invention;

FIG. 3 is a perspective view of a bank of wagering game machines, according to embodiments of the invention;

FIG. 4 is a schematic diagram illustrating a networked wagering game system, according to embodiments of the invention;

FIG. 5 is an image of a game screen of a wagering game that may be displayed on a wagering game machine, according to an embodiment of the invention;

FIGS. 6-10 are flow diagrams illustrating methods for choreographing an audio presentation among a plurality of wagering game machines, according to embodiments of the invention;

FIG. 11 is an image of a multi-display presentation, according to embodiments of the invention; and

FIGS. 12A-12D are images of a multi-display presentation during an example game play, according to embodiments of the invention.

### DETAILED DESCRIPTION

The following detailed description refers to the accompanying drawings that depict various details of examples selected to show how the present invention may be practiced. The discussion addresses various examples of the inventive subject matter at least partially in reference to these drawings, and describes the depicted embodiments in sufficient detail to enable those skilled in the art to practice the invention. Many other embodiments may be utilized for practicing the inventive subject matter other than the illustrative examples discussed herein, and many structural and operational changes in addition to the alternatives specifically discussed herein may be made without departing from the scope of the inventive subject matter.

### Operating Environment

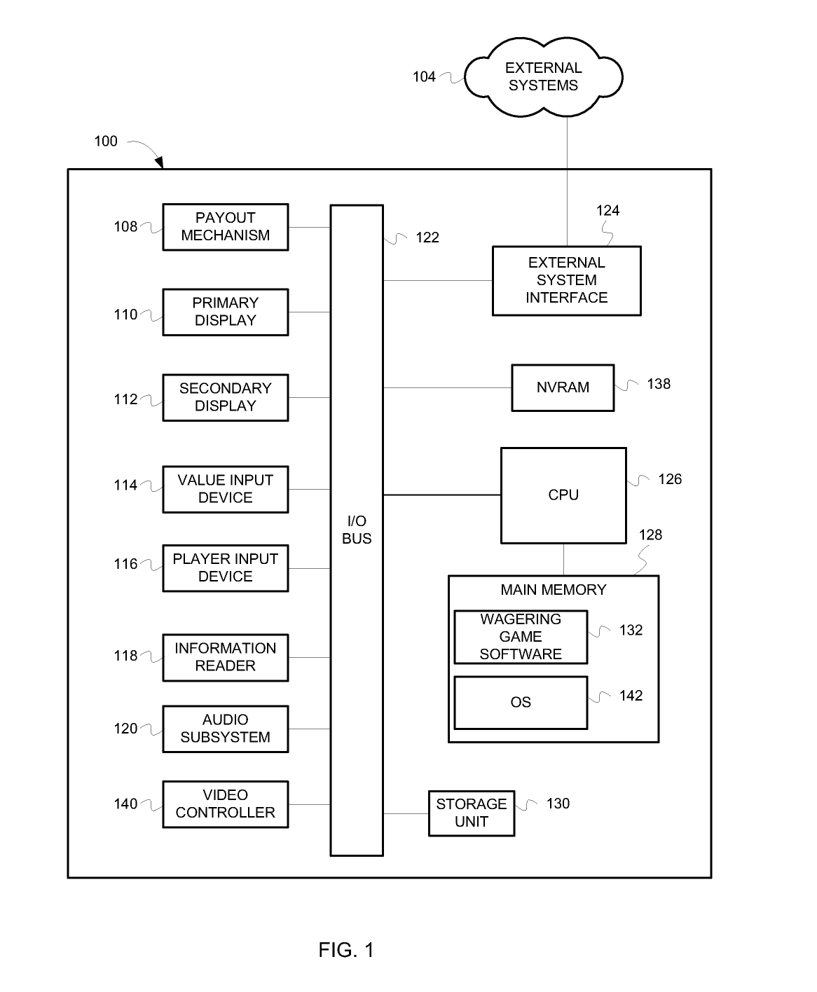

FIG. 1 is a block diagram illustrating a wagering game machine according to embodiments of the invention. In an embodiment, the wagering game machine 100 receives wagers and conducts wagering games, such as video poker, video blackjack, video slots, video lottery, etc. The wagering game machine 100 comprises a central processing unit (CPU) 126 connected to main memory 128, which includes some or all of wagering game software 132 and some or all of an operating system (OS) 142. An NVRAM (Non-Volatile Random Access Memory) module 138 is connected to the CPU 126 via the input/output (I/O) bus 122. In some embodiments the NVRAM module 138 may be directly connected to the CPU 126.

In some embodiments, the NVRAM module 138 is a battery-backed random access memory (RAM). In other embodiments, the NVRAM module 138 comprises a flash memory module, magnetic RAM, FeRAM, phase-change memory (PRAM), optical RAM (ORAM), carbon nanotube technology, some combination of these types, or other types of memory capable of preserving information when operational power is removed.

The I/O bus 122 facilitates communication between components of the wagering game machine 100. The I/O bus 122 is connected to a payout mechanism 108, primary display 110, secondary display 112, value input device 114, player input device 116, information reader 118, audio subsystem 120, and storage unit 130 (e.g., a disk drive or flash memory device). The player input device 116 can include the value input device 114 to the extent the player input device 116 is used to place wagers. In an embodiment, the value input device 114 can electronically receive wagering value (e.g., monetary value) from a player's casino account or other suitable “cashless gaming” value source. The I/O bus 122 is also connected to an external system interface 124, which is in turn connected to external systems 104 (e.g., wagering game networks).

In an embodiment, the audio subsystem 120 is configurable to operate in at least two modes: a first mode having a default volume setting and a second mode having a user-selected or user-defined volume setting. When the wagering game machine 100 is initially set up and configured, one of the configuration settings is a default cabinet volume. The default cabinet volume value is stored, for example, in the NVRAM module 138. During game play, a player may adjust the volume using the player input device 116. The player-defined volume setting may be stored in main memory 128 and be used to configure the audio subsystem 120 to output audio at a specified volume.

The audio subsystem 120 can be used to play one or more audio files. As used herein, an “audio file” means a file that may be used to provide audible audio content through an appropriate output device (such as any of the various forms of “speakers”), and thus embraces both stored audio waveforms and files containing data and/or instructions facilitating generation of the audio content through use of an audio protocol. In all cases, regardless of the type of file from which the audible audio content is generated (and thus regardless of the specific process of such generation), generating that audio content is identified herein as “playing” the audio content or the audio file. In the case of files of stored waveforms, waveforms may be stored in either in a compressed or uncompressed format. Examples of compressed audio formats include, but are not limited to, MP3, Vorbis, Musepack, AAC, and WMA. Compressed audio formats with lossless compression, such as MPEG-4, Apple® Lossless, and WMA Lossless are also contemplated to be within the scope of the term audio file. Examples of uncompressed audio formats include, but are not limited to, WAV, AIFF, AU, BWF (Broadcast Wave Format), or raw header-less PCM. MIDI is a popular audio protocol that does not store an actual audio signal, but instead stores instructions to create event messages about pitch and intensity, and control signals regarding parameters such as volume, vibrato, panning, cues, and clock tempo. Other audio protocols include OSC (Open Sound Control), mLAN (from Yamaha®), and HD Protocol.

In one example embodiment, the wagering game machine 100 is one of a plurality of wagering game machines that at some points in time cooperate in a shared wagering game. Wagering game machines may operate generally independently from each other during non-shared games. But at some point the wagering game machines can cooperatively function together in a coordinated manner, in a shared game (also termed a “community game”), to provide community experience to the players. Such a shared game may be offered, for example, as a bonus game, in addition to other games played on the individual wagering game machine. The shared game can be controlled and provided by any of a number of possible physical configurations. As just an example, a shared game might be controlled entirely from a central server that either serves other functions or is dedicated to serving one or more shared games. In other configurations, the shared game might be controlled from one of the involved wagering game machines that exercises control functions outside the machine at least when offering a shared game. Many other physical configurations are possible. As a result, when the present disclosure identifies that the “shared game” provides some information or exercises some form of control, it should be understood that the control is actually coming from the various instrumentalities (hardware, software, firmware, etc) that are used to provide the shared game functionality and user experience.

One aspect of this cooperative functioning will preferably be providing a selected audio experience to the players, which may be accomplished under the control of the shared game. Providing that selected audio experience will include controlling one or more audio parameters of some or all of the wagering game machines participating in the shared game. Such audio parameters include one or more of: the audio playback level on the individual wagering game machines, the audio content that is played, the time and/or sequence of playing of the audio content, etc. Thus, in some examples, during the shared game the volume of each of the wagering game machine is reset to common volume prior to presenting the shared experience (the shared game). In an example instance, the common volume may be a default level, such as the established cabinet volume. In another instance, the common level is a predefined volume that may be higher or lower than a default volume. In some further example configurations, after the shared game is completed, the audio playback volume setting of each involved wagering game machines will be returned to the original level it was at before the shared game. In some examples, these original levels may be respective player-defined volume settings set on each machine by the respective players. By allowing the shared game to control the audio volume setting of each wagering game machine during the shared game, the shared game is able to present a consistent and controlled auditory experience for the players at the wagering game machines.

In an embodiment, the primary display 110 is controlled by a video controller 140. The video controller 140 can include hardware integrated on a motherboard or incorporated in an expansion card. In general, video controllers are used to generate images to output via a display. Some video controllers are configured to provide additional functions, such as accelerated 3D rendering, video encoding or decoding, or video capture, for example. Video controllers may share system memory, such as main memory 128, or some controllers may have dedicated memory. In an embodiment, the video controller 140 is configured to output a visual presentation in synchronicity with a played audio file.

In an embodiment, the machine 100 can include additional peripheral devices and/or more than one of each component shown in FIG. 1. For example, in an embodiment, the machine 100 can include multiple external system interfaces 124 and multiple CPUs 126. In various embodiments, components can be integrated or subdivided. Additionally, in an embodiment, the components of the machine 100 can be interconnected according to any suitable interconnection architecture (e.g., directly connected, hypercube, etc.).

In an embodiment, any of the components of the machine 100 can include hardware, firmware, and/or software for performing the operations described herein. Furthermore, any of the components can include machine-readable media including instructions stored thereon for causing a machine to perform the operations described herein. Machine-readable media includes any mechanism that stores information in a form readable by a machine (e.g., a wagering game machine, computer, etc.). For example, tangible machine-readable media includes read only memory (ROM), RAM, magnetic disk storage media, optical storage media, flash memory, other forms of nonvolatile memory, etc.

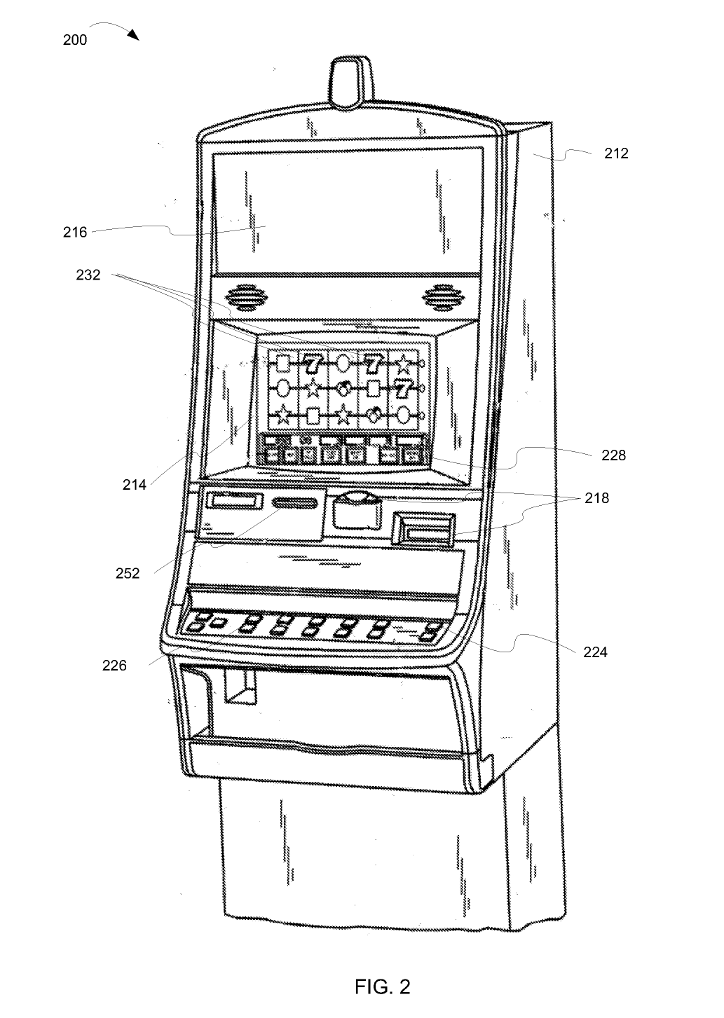

FIG. 2 is a perspective view of a wagering game machine, according to embodiments of the invention. The wagering game machine 200 may be used in gaming establishments, such as casinos. According to various embodiments, the wagering game machine 200 can be any type of wagering game machine and can have varying structures and methods of operation. For example, the wagering game machine 200 can be an electromechanical wagering game machine configured to play mechanical slots, or it can be an electronic wagering game machine configured to play video casino games, such as blackjack, slots, keno, poker, blackjack, roulette, etc. In some embodiments, the wagering game machine 200 is similar to or identical to the wagering game machine 100 illustrated in FIG. 1.

The wagering game machine 200 comprises a housing 212 and includes input devices, including value input devices 218 and a player input device 224. For output, the wagering game machine 200 includes a primary display 214 for displaying information about a wagering game. The primary display 214 can also display information about a bonus wagering game or a progressive wagering game. The wagering game machine 200 also includes a secondary display 216 for displaying wagering game events, wagering game outcomes, and/or signage information. While some components of the wagering game machine 200 are described herein, numerous other elements can exist and can be used in any number or combination to create varying forms of the wagering game machine 200.

The value input devices 218 can take any suitable form and can be located on the front of the housing 212. The value input devices 218 can receive currency and/or credits inserted by a player. The value input devices 218 can include coin acceptors for receiving coin currency and bill acceptors for receiving paper currency. Furthermore, the value input devices 218 can include ticket readers or barcode scanners for reading information stored on vouchers, cards, or other tangible portable storage devices. The vouchers or cards can authorize access to central accounts, which can transfer money to the wagering game machine 200.

The player input device 224 comprises a plurality of push buttons on a button panel 226 for operating the wagering game machine 200. In addition, or alternatively, the player input device 224 can comprise a touch screen 228 overlaid on top of the primary display 214 and/or secondary display 216. The player input device 224 can be used to control the volume output of the wagering game machine 200. The volume output may be set to varying levels including muting the volume altogether.

The various components of the wagering game machine 200 can be connected directly to, or contained within, the housing 212. Alternatively, some of the wagering game machine's components can be located outside of the housing 212, while being communicatively coupled with the wagering game machine 200 using any suitable wired or wireless communication technology.

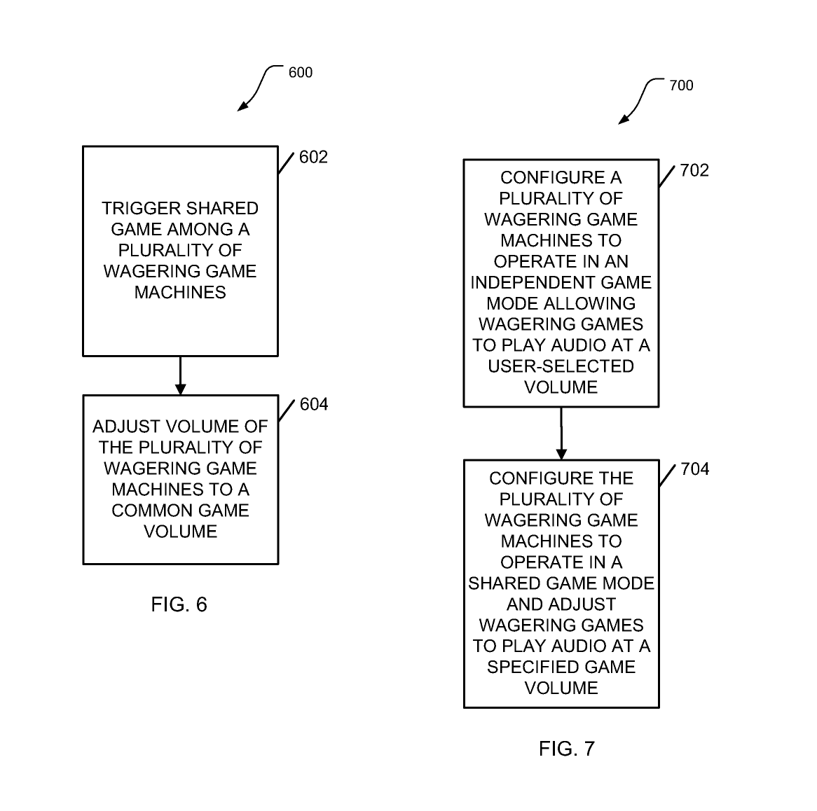

The operation of the basic wagering game can be displayed to the player on the primary display 214. The primary display 214 can also display a bonus game associated with the basic wagering game. The primary display 214 can include a cathode ray tube (CRT), a high resolution liquid crystal display (LCD), a plasma display, light emitting diodes (LEDs), or any other type of display suitable for use in the wagering game machine 200. Alternatively, the primary display 214 can include a number of mechanical reels to display the outcome. In FIG. 6, the wagering game machine 200 is an “upright” version in which the primary display 214 is oriented vertically relative to the player. Alternatively, the wagering game machine can be a “slant-top” version in which the primary display 214 is slanted at about a thirty-degree angle toward the player of the wagering game machine 200. In yet another embodiment, the wagering game machine 200 can exhibit any suitable form factor, such as a free standing model, bartop model, mobile handheld model, or workstation console model. Further, in some embodiments, the wagering game machine 200 may be include an attached chair assembly, and may include audio speakers designed to provide an enhanced audio environment. For example, a “surround sound” system may be included as part of the wagering game machine and may be integrated with an attached chair.

A player begins playing a wagering game by making a wager via the value input device 218. The player can initiate play by using the player input device's buttons or touch screen 228. The wagering game can include arranging a plurality of symbols along a payline 232, which indicates one or more outcomes of the basic game. Such outcomes can be randomly selected in response to player input. At least one of the outcomes, which can include any variation or combination of symbols, can trigger a bonus game.

In some embodiments, the wagering game machine 200 can also include an information reader 252, which can include a card reader, ticket reader, bar code scanner, RFID transceiver, or computer readable storage medium interface. In some embodiments, the information reader 252 can be used to award complimentary services, restore game assets, track player habits, etc. The information reader 252, the value input device 218, and/or the player input device 224, among other devices, can be used to send or receive signals that set a cabinet volume.

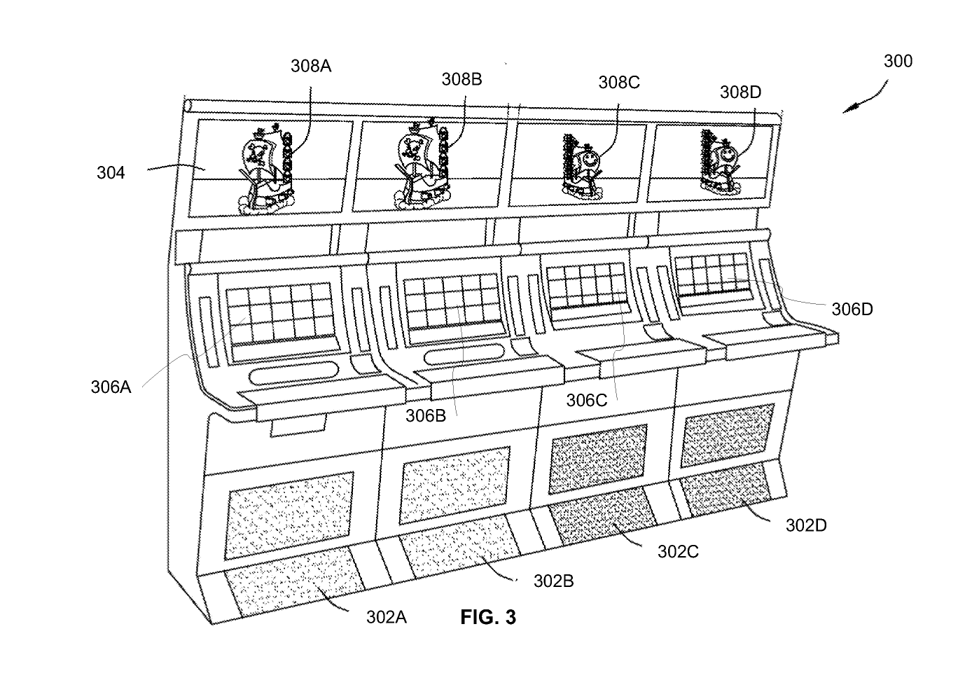

Referring now to FIG. 3, a bank of wagering game machines 300 is shown according to an embodiment. In this embodiment, wagering game machines 302A, 302B, 302C, 302D are arranged adjacent to each other in a row. A base game can be played at each wagering game machine 302A-D. In the depicted example, a shared secondary display 304 is placed above the bank of wagering game machines 302A-D. The shared secondary display 304 can comprise of a single display screen or multiple display screens configured to function together as a single continuous display. In the embodiment illustrated in FIG. 3, each wagering game machine 302A-D has its own primary display 306A-D and secondary display 308A-D, similar to that found in FIG. 2. The proximity of the secondary displays 308A-D is used to create a shared secondary display 304, or a “metascreen,” that acts as a single display for the bank of wagering game machines. This shared secondary display can be used for displaying a visible representation during the shared game (as well as for other purposes). In the embodiment illustrated in FIG. 3, the shared secondary display 304 is used to present a shared bonus game. Portions of the shared bonus game are spanned across the width of the shared secondary display 304. When a video object is displayed and tracks from an area above one wagering game machine to an area above another wagering game machine, an associated audio portion can be presented, where the audio portion is choreographed with the video object's movement. In other examples, a visible representation may be displayed during the shared game in the absence of a shared display (or any external display), and may be displayed using just the primary displays 306A-D of each wagering game machine 302A-D.

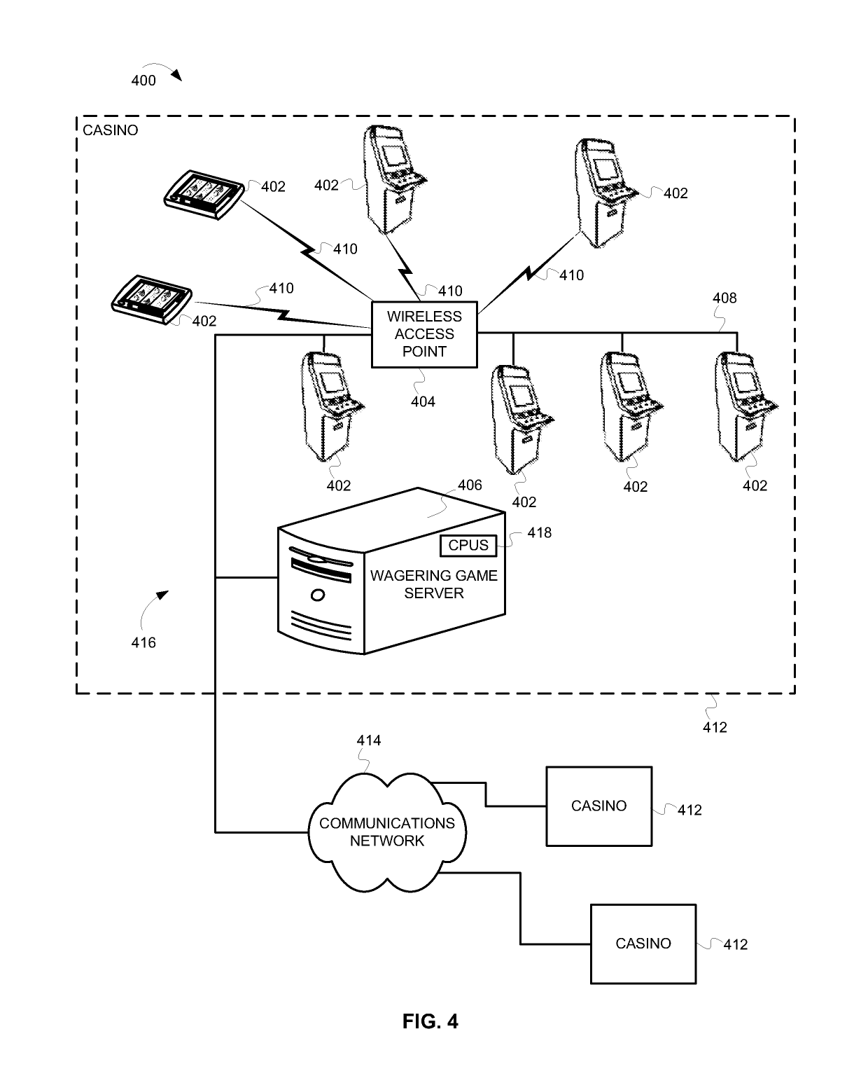

In other embodiments, the shared secondary display 304 is used to present an attract presentation to advertise the game, casino services, or other products or services. For example, an advertiser may enter a contract with a host casino and/or a wagering game manufacture to advertise a product or service on a shared secondary display over a bank of wagering game machines. Audio associated with the visual presentation may be provided as described herein.

Where FIGS. 1, 2, and 3 describe example embodiments of wagering game machines, including exemplary architectures, FIG. 4 illustrates how a plurality of wagering game machines 100 can be connected in a networked wagering game network.

Thus, FIG. 4 is a schematic diagram illustrating a networked wagering game system, according to embodiments of the invention. As shown in FIG. 4, the wagering game network 400 includes a plurality of casinos 412 connected to a communications network 414. Each of the plurality of casinos 412 includes a local area network 416, which may include a wireless access point 404, wagering game machines 402, and a wagering game server 406 that can serve wagering games over the local area network 416. The local area network 416 includes wireless communication links 410 and wired communication links 408. The wired and wireless communication links 410, 408 can employ any suitable connection technology, such as Bluetooth, IEEE 802.11, Ethernet, public switched telephone networks, SONET, etc. In an embodiment, the wagering game server 406 can serve wagering games and/or distribute content to devices (e.g., wagering game machines 402) located in other casinos 412 or at other locations on the communications network 414. In an embodiment, a wagering game machine 402 may act as a server and perform some or all of the functions of a wagering game server 406.

The wagering game machines 402 and wagering game server 406 can include hardware and machine-readable media including instructions for performing the operations described herein.

The wagering game machines 402 can take any suitable form, such as floor standing models, handheld mobile units, bartop models, workstation-type console models, etc. Further, the wagering game machines 402 can be primarily dedicated for use in conducting wagering games, or can include non-dedicated devices, such as mobile phones, personal digital assistants, personal computers, etc. In an embodiment, the wagering game network 400 can include other network devices, such as accounting servers, wide area progressive servers, player tracking servers, and/or other devices suitable for use in connection with embodiments of the invention. The machines 402 may be similar to or identical to the machine 100 of FIG. 1.

In embodiments, wagering game machines 402 and wagering game servers 406 work together such that a wagering game machine 402 may be operated as a thin, thick, or intermediate client. For example, one or more elements of game play may be controlled by the wagering game machine 402 (client) or the wagering game server 406 (server). Game play elements may include executable game code, lookup tables, configuration files, game outcome, audio or visual representations of the game, game assets or the like. In a thin-client example, the wagering game server 406 may perform functions such as determining game outcome or managing assets, while the wagering game machine 402 may be used merely to present a graphical representation of such outcome or asset modification to the user (e.g., player). In a thick-client example, game outcome may be determined locally (e.g., at the wagering game machine 402) and then communicated to the wagering game server 406 for recording or managing a player's account.

Similarly, functionality not directly related to game play may be controlled by the wagering game machine 402 (client) or the wagering game server 406 (server) in embodiments. For example, power conservation controls that manage a display screen's light intensity may be managed centrally (e.g., by the wagering game server 406) or locally (e.g., by the wagering game machine 402).

Server 406 may comprise an AOM (Administration, Operations, and Maintenance) server. In these embodiments, server 306 may issue commands or respond to requests from wagering games to load software onto a wagering game machine, and may issue commands to cause a wagering game to be rebooted or control volume settings for a wagering game machine 402, as described below. Thus, additional embodiments may be realized.

In various embodiments, volume settings for a wagering game machine 402 may be set locally at the wagering game machine 402, such as by a game operator or player, or may be controlled remotely from the wagering game server 406.

For example, in some embodiments, a wagering game server 406 can include one or more processors 418 communicatively coupled to a memory (e.g., the memory 138 of FIG. 1) storing an operating system having instructions for remotely controlling volume at one or more wagering game machines 402.

The system 400 may include a client to receive wagers, and to display the outcome of the wagering game, as generated by the server 406. Thus, the system 400 may comprise one or more clients (e.g., perhaps the machines 402) coupled to the wagering game server 406 by a network 404, the client operable to receive a wager from a player, and to display a wagering game outcome generated by the wagering game server 406. Still further embodiments may be realized.

In some embodiments, the wireless access point 404 can form part of a communication station, such as wireless local area network (WLAN) communication station including a Wireless Fidelity (WiFi) communication station, or a WLAN access point (AP). In these embodiments, the wagering game machines 402 can form part of a mobile station, such as WLAN mobile station or a WiFi mobile station.

In some embodiments, the wireless access point 404 can form part of a broadband wireless access (BWA) network communication station, such as a Worldwide Interoperability for Microwave Access (WiMax) communication station, since the wireless access point 404 can be part of almost any wireless communication device. In these embodiments, the wagering game machines 402 can be part of a BWA network communication station, such as a WiMax communication station.

In some embodiments, any of the wagering game machines 402 may comprise a portable wireless communication device, such as a personal digital assistant (PDA), a laptop or portable computer with wireless communication capability, a web tablet, a wireless (e.g., cellular) telephone, a wireless headset, a pager, an instant messaging device, a digital camera, a television or other device that can receive and/or transmit information wirelessly.

In some embodiments, the wireless access point 404 and the wagering game machines 402 can communicate RF signals in accordance with specific communication standards, such as the Institute of Electrical and Electronics Engineers (IEEE) standards including IEEE 802.11(a), 802.11(b), 802.11(g), 802.11(h) and/or 802.11(n) standards and/or proposed specifications for wireless local area networks, among others. In some BWA network embodiments, the wireless access point 404 and the wagering game machines 402 can communicate RF signals in accordance with the IEEE 802.16-2004 and the IEEE 802.16(e) standards for wireless metropolitan area networks (WMANs) including variations and evolutions thereof. However, they can also be suitable for communicating in accordance with other techniques and standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” Can 2005 and related amendments/versions.

In other embodiments, the wireless access point 404 and the wagering game machines 402 can communicate in accordance with a short-range wireless standard, such as the Bluetooth™ short-range digital communication protocol.

It will be appreciated from the above that components of a wagering game architecture and/or their functionality may be distributed in various ways. For example, all of the components and functionality may reside in a wagering game machine, or various portions may reside in part on a wagering game machine and in part on a server or other network attached device. The scope of the inventive subject matter is meant to include all of these environments and implementations.

### User Interface

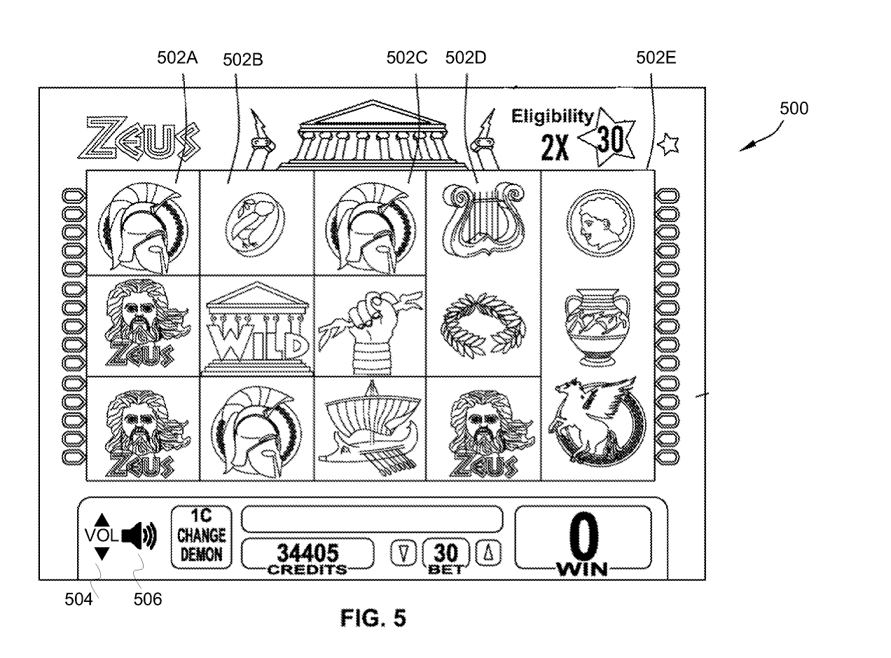

Turning now to FIG. 5, an image of a game screen 500 adapted to be displayed on the primary display area, such as primary display 110 of FIG. 1 (or a portion thereof) of wagering game machines. The game screen 500 includes a touch screen component that overlays at least the bottom portion of the game screen 500 in order to allow a player to control and configure the game. In FIG. 5 the game screen 500 portrays a plurality of simulated movable reels 502A-E. Alternatively or additionally, the game screen 500 may provide a view of a plurality of mechanical reels, or a combination of simulated and mechanical reels. The game screen 500 also includes several game-session meters, for example to keep track of a number of credits or credits wagered in a particular play at the game.

In addition, the game screen 500 includes a volume control 504. The volume control 504 includes a volume setting indicium 506. In this example, the volume setting indicium 506 is a speaker icon with curves that indicate the strength of the volume output. If the volume is muted, a speaker icon with a red “x” may be displayed to indicate the muted state. It is understood that other types of volume controls and volume setting indicia may be used.

In an example embodiment, the volume setting indicium 506 also acts as a volume control mechanism. For example, a user may tap the volume setting indicium to cycle through the volume settings incrementally from a minimum volume to a maximum volume, such that when the volume cycles back to the minimum volume when the volume control is actuated at the maximum volume setting. A specific example includes using “low volume,” “medium volume,” “high volume,” and mute—represented graphically with one, two, and three graphical sound waves and a speaker with a red “x” through it. A user can tap on the volume setting indicium 506 to cycle the volume setting through the states.

In various implementations, a mechanical volume control, such as a rotary control knob, or an electro-mechanical control, such as a switch may be used to control the output volume. A rotary control can include in various embodiments, an analog or digital control. An analog control can include one or more of a rotary switch, a potentiometer, a variable capacitor, or one or more other analog controls alone or in combination. A digital control can include a rotary pulse generating control, a rotary encoder, or an electro-optical rotary input. Switches can include, but are not limited to, a toggle switch, a slide switch, a membrane switch (e.g., a carbon pill switch), or one or more other switches alone or in combination. In other various embodiments, the volume control 504 can include an electronic input overlaying or in proximity to the display, where the electronic input may be a thin-film touch-sensitive overlay, an optically-scanned input configured to detect a user input, or one or more soft-keys such as a mechanical switch aligned with a particular portion of the display with an input function determined by the display context.

### Operating Methods

FIGS. 6-8 illustrate methods for choreographing an audio presentation among a plurality of wagering game machines, according to embodiments of the invention. Describing the methods by reference to a flow diagram enables one of ordinary skill in the art to develop such programs including instructions to carry out the method on suitable processors for gaming machines (the processor or processors of the computer executing the instructions from computer-readable media). Accordingly, in some embodiments, method processes are implemented as instructions on a computer-readable medium. The methods illustrated in FIGS. 6-10 include operations that may be performed by an operating environment executing embodiments of the invention.

FIG. 6 is a flow diagram illustrating a method 600 for choreographing an audio presentation among a plurality of wagering game machines, according to example embodiments of the invention.

As discussed above, a wagering game machine of the plurality of wagering game machines includes a configurable volume controllable by the player. It is understood that each wagering game in a group of wagering game machines may be configured to play audio at a different volume depending on the players' preferences at each of the respective wagering game machines in the group.

At block 602, a shared game is triggered among the plurality of wagering game machines. For example, the wagering game server 406 can serve wagering games and/or distribute content to the plurality of wagering game machines. In another example, one of the plurality of wagering game machines acts as a server and serves wagering games or content to others of the plurality of wagering game machines. In either case, a shared game can be initiated by a game server.

At block 604, during the shared game, the plurality of wagering game machines are adjusted to play audio at a specified common volume instead of the respective user-selected volumes.

The specified common volume is a volume that normalizes the volume among the plurality of wagering game machines. The specified common volume may be a default volume, which may be preset by a game operator or owner during initial set up, for example. The specified common volume may also be an arbitrary volume chosen for the audio performance, which may be louder or softer than a default volume. Regardless of how the value of the specified common value is determined, a common volume setting is implemented to homogenize volumes or make volumes substantially uniform throughout the plurality of wagering game machines.

At or after a conclusion of the shared game, the plurality of wagering game machines are adjusted to play audio at the respective previously-configured user-selected volumes; thus restoring the players' preferred volume settings.

In an example embodiment, wagering game machines are configured to store an audio file, such as in main memory 128 or the storage unit 130, for example. The audio presentation can then be choreographed among the plurality of wagering game machines by triggering play of the audio file at each of the respective wagering game machines. Triggering play of the audio file may be performed with various mechanisms, including but not limited to, a remote procedure call.

In an example embodiment, the audio presentation is presented in coordination with a visual presentation; and in some examples in synchronicity with that visual presentation. The visual presentation can be displayed on a shared secondary display 304, on a primary display 110, or on a combination of displays 304, 110. In an embodiment, the visual presentation spans the plurality of wagering game machines and the audio presentation tracks movement within the visual presentation.

The visual presentation may comprise a game event, such as a bonus game, or a non-game event, such as advertising. Further, the visual presentation may include video (e.g., animated video, broadcast video, live video, pre-recorded video, and the like), lights (e.g., a lightshow, a laser show, and the like), slideshows, or combinations of such presentations.

In an embodiment, separate commands can be individually addressed and communicated to each wagering game machine to adjust the plurality of wagering game machines to play audio at the specified common volume comprises. Alternatively, in another embodiment, a broadcast command can be used to signal wagering game machines to normalize output volume setting, begin audio playback, begin video playback, or direct other performances at a wagering game machine.

FIG. 7 is a flow diagram illustrating a method 700 for choreographing an audio presentation among a plurality of wagering game machines where each wagering game machine capable of being played in an independent game mode and a shared game mode, according to example embodiments of the invention. An independent game mode is a mode where each of the wagering game machines operates independently from each other. A shared game mode is where two or more wagering game machines operate in a shared, or community, game. In some embodiments, the independent game mode is mutually exclusive from the shared game mode. In other embodiments, a wagering game machine can operate simultaneously in both the independent game mode and the shared game mode. For example, a solo game may be presented on the primary display 110 while a community game may be presented on the secondary display 112.

At block 702, the plurality of wagering game machines are configured to operate in the independent game mode and while in the independent game mode the wagering game machines are allowed to be configured by respective users to play audio at respective user-selected volumes. Each user-selected volume are configurable to be different from each other.

At block 704, the plurality of wagering game machines are configured to operate in the shared game mode and while in the shared game mode the plurality of wagering game machines are adjusted to play audio at a specified game volume shared among the plurality of wagering game machines instead of the individual respective user-selected volumes. The specified game volume may include a predetermined volume setting, such as a default cabinet volume. Alternatively, the specified game volume may be provided to the wagering game machine from the game server, such as by way of a function call parameter.

After the shared game completes, or at the time the share game completes, the wagering game machine is configured back to the independent game play mode. In response to switching the plurality of wagering game machines back to the independent game mode from the shared game mode, the plurality of wagering game machines are adjusted to play audio at the respective user-selected volumes.

In some embodiments, each of the plurality of wagering game machines can be configured to store an audio file associated with the shared game mode. During the shared game play, each of the plurality of wagering game machines is instructed to play the respective audio file.

In an example embodiment, the audio presentation is presented in coordination with a visual presentation. The visual presentation is presented in proximity to the plurality of wagering game machines. For example, the visual presentation can be displayed on a shared secondary display 304, on a primary display 110, or on a combination of displays 304, 110. As another example, the visual presentation may be presented on the ceiling or walls of a room in which the wagering game machines are located. The visual presentation may be implemented using lights, video displays, projected images, and the like. In an embodiment, the audio presentation tracks motion within the visual presentation.

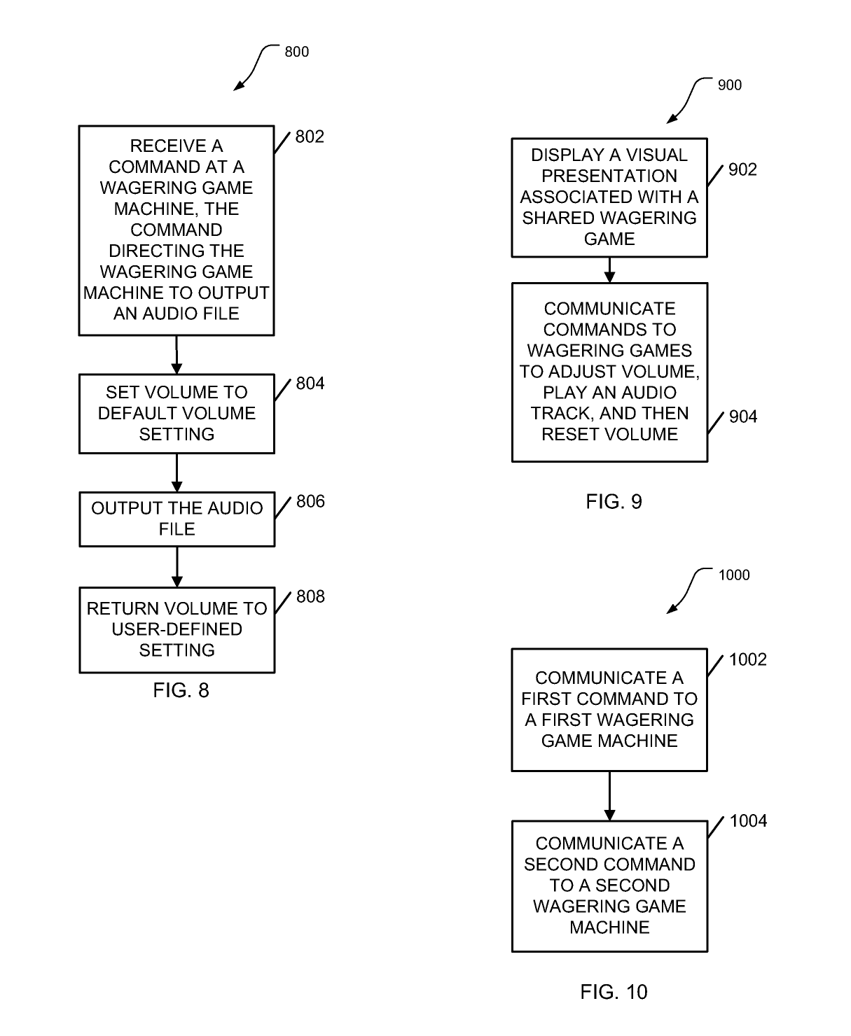

FIG. 8 is a flow diagram illustrating a method 800 for choreographing an audio presentation among a plurality of wagering game machines, according to example embodiments of the invention.

At block 802, a command is received at a wagering game machine of a plurality of wagering game machines. The received command is from a source external to the wagering game machine and the command directs that an audio file stored in the wagering game machine be output as part of the audio presentation.

As discussed above with respect to FIG. 1, a wagering machine may be configured with a default cabinet volume and be capable of receiving and storing a player-defined volume setting. Thus, in an embodiment, the wagering game machine includes a default volume setting and a user-defined volume setting.

According to such an embodiment, at block 804, a volume of the wagering game machine is set to the default volume setting before outputting the audio file. At block 806, the audio file is output at the wagering game machine and in choreographed relation to a visually observable presentation. At block 808, the volume of the wagering game machine is returned back to the user-defined volume setting after outputting the audio file.

Many times the visually observable presentation is part of a wagering game, such as during a bonus round or some other special event within a game. Thus, in an embodiment, the audio presentation and the visually observable presentation are incorporated into a wagering game. In other instances, the visually observable presentation is not directly related to a wagering game or game play, but communicates with the players or contributes to the player experience separate from the actual game play. Examples include advertising presentations. Thus, in some embodiments, the audio presentation and the visually observable presentation are unrelated to wagering game play.

Visually observable presentations with associated audio presentations can be used in an overlay game for multiple players, such as a community or shared game. Thus, in an embodiment, the wagering game is a multi-player wagering game.

In some instances, a wagering game server is used to coordinate and run a shared game. For example, a wagering game server may be incorporated into a shared display area and issue commands to the wagering game machines associated with the shared display area. Thus, in an embodiment, the command is received from a wagering game server.

In some instances, the wagering game machine is used to provide at least some of the visual presentation, such as for example on the primary display 110. Thus, in a further embodiment, the visually observable presentation is displayed on a display that is a part of the wagering game machine.

FIG. 9 is a flow diagram illustrating a method 900 for choreographing an audio presentation among a plurality of wagering game machines physically arranged in an organized manner and configured to participate in a shared wagering game, according to example embodiments of the invention.

At block 902, a visual presentation associated with the shared wagering game is displayed. The visual presentation is displayed spanning the plurality of wagering game machines. As discussed above with respect to FIG. 3, spanning a visual presentation across a bank of wagering game machines may be achieved by either using a single display that physically spans the dimensions of the bank of machines, or by using several displays in combination to create a “metascreen” that spans the dimensions of the bank of machines. Other combinations may be considered to be within the scope of this disclosure. For example, wagering game machine displays may be combined with other displays mounted in proximity to the wagering game machines to create a “metascreen.”

At block 904, a series of commands are communicated from a wagering game server to the plurality of wagering game machines, the series of commands to cause each of the wagering game machines of the plurality of wagering game machines to configure an output volume by changing the output volume from a respective current established volume level to a common predetermined volume level. The respective current established volume level may be a player-defined volume. For example, people who are overwhelmed by the myriad of sounds emanating from a wagering game machine may choose to lower the volume, or even mute the machine, in order to better enjoy their experience. The predetermined volume level may be set by a game operator, such as during set up or configuration of the wagering game machine.

After changing the output volume, the series of commands cause each wagering game machine of the plurality of machines to play an audio file (or a portion thereof) from a memory of a wagering game machine.

In one example embodiment, after playing the audio file, the series of commands cause each of the wagering game machines of the plurality of wagering game machines to configure the output volume to return to the respective established volume level.

In another example embodiment, at or after completion of the shared wagering game, the series of commands cause each wagering game machine of the plurality of machines to configure the output volume to the respective established volume level existing before the shared game control of the audio level.

The series of commands may be implemented in various ways according to various embodiments. For example, individual commands to change the output volume to a pre-determined volume level, play an audio file, and configure the output volume to restore the previously-used volume may be broadcast to a bank of machines resulting in three distinct broadcasts. As another example, the individual commands may be individually addressed to each wagering game machine in a bank resulting in a number of commands equal to three times the number of wagering game machines. Other combinations are possible and understood to be within the scope of this disclosure.

FIG. 10 is a flow diagram illustrating a method 1000 for choreographing an audio presentation among a plurality of wagering game machines, according to example embodiments of the invention.

At block 1002, a first command is communicated to a first wagering game machine of the plurality of wagering game machines. The first command is configured to cause the first wagering game machine to play a first audio file stored on the first wagering game machine. The first audio file may be stored in main memory 128 or the storage unit 130, for example. In alternative embodiments, the audio file may be stored external from the wagering game machine and be accessed, for example, over a network.

At 1004, a second command is communicated to a second wagering game machine of the plurality of wagering game machines. The second command is configured to cause the second wagering game machine to play a second audio file stored on the second wagering game machine. The playing of the second audio file is performed in a predetermined relation to the playing of the first audio file. In an embodiment, the predetermined relation may be stored as a portion of game code; while in other embodiments, the predetermined relation can be provided by a user. The predetermined relation may cause the first and second wagering game machines to play audio files one after another, or to play audio files synchronized with each other.

In an example embodiment, the first and second audio files are played in association with a visual presentation; and in some examples in synchronicity with that visual presentation. The visual presentation can be displayed on a shared secondary display 304, on a primary display 110, or on a combination of displays 304, 110. The visual presentation may comprise a game event, such as a bonus game, or a non-game event, such as advertising. Further, the visual presentation may include video (e.g., animated video, broadcast video, live video, pre-recorded video, and the like), lights (e.g., a lightshow, a laser show, and the like), slideshows, or combinations of such presentations.

While in some instances the wagering game machine controls a visual presentation on its own display, in other instances a server controls such displays. Thus, in an embodiment, the first command is communicated from a wagering game server to the plurality of wagering game machines and the first and second audio files are played in synchronicity with a visual presentation controlled by the wagering game server. In an embodiment, a wagering game machine is configured to act as the wagering game server. In such an embodiment, the wagering game machine acting as a wagering game server may also act in a dual role as a client of the game it is serving or as a client of another game.

In a further embodiment, a third command is communicated to a third wagering game machine of the plurality of wagering game machines. The third command is configured to cause the third wagering game machine to play a third audio file stored on the third wagering game machine. Playing of the third audio file is performed in a predetermined pattern in combination with the playing of the first and second audio files. In one instance where wagering game machines are arranged in a row, the pattern is a sequence starting at one end of the row and proceeding to the other end of the row. Other patterns are understood to be within the scope of this disclosure, including pseudo-random patterns, circular patterns, parallel patterns, and the like. For example, in an arrangement of two linear banks of machines facing each other, a parallel pattern may be used to display a moving object above both banks, where the objects mirror each other's movement and the audio in each bank tracks the respective object. As another example, in a roughly circular arrangement of wagering game machines, a game like “Duck Duck Goose” or “Musical Chairs” can be adapted and presented in a circular pattern among the game machines.

In some instances not all players in a group of wagering game machines are included in the shared wagering game. For example, players may have to qualify for participation in the shared game. Winners of the shared game are then selected from the players who qualified. In an example embodiment, when a player does not qualify for a shared wagering game, the player's wagering game machine may not be included in the shared audio presentation. In an alternative embodiment, the non-qualified player's wagering game machine is included in the audio presentation, resulting in a more consistent presentation.

In a further embodiment, at least one volume command is communicated to the plurality of wagering game machines. The at least one volume command is configured to cause each of the wagering game machines to set an output volume to a default mode before outputting an audio file In an embodiment, the volume command or another command is configured to set the output volume to a user-defined mode after outputting the audio file. Volume normalization avoids the problems that may occur when one player has a relatively high volume setting in relation to a nearby player who has a relatively low volume setting. By normalizing the volume across a bank of wagering game machines, sound effects can be produced more consistently and better appreciated by the players.

As just one example, audio content associated with movement of a visual object across a shared display can be effective in conveying the movement through changes in the audio content volume across the involved wagering game machines; but this effectiveness would be lost or diminished if the audio volumes on the involved wagering game machines provided volume variations not contemplated when the audio files were generated and/or their playback designed. A similar problem may exist when one player with a relatively low volume setting is unable to hear output at their particular wagering game machine because of nearby players with relatively high volume settings. These types of issues with volume variations may be overcome with volume normalization.

In the case of a non-qualifying player or a non-participating player, that player's wagering game machine's volume may be normalized to provide a consistent audio environment. It may also be the case that the non-qualifying or non-participating player's machine is not included in the audio presentation and thus, the wagering game machine's output volume does not get normalized with its neighbors.

In some embodiments, volume normalization is optional; and where implemented, volume normalization can be initiated by various mechanisms or instruction sequences. As but two examples, volume normalization might be implemented by one or more initial commands prior to most other shared game commands (for example, as part of a shared game initiations sequence); or might be initiated during the shared game play, such as in combination with an instruction to play a selected audio file. An example implementation of such a command is: playAudio (audio_id, normalize_volume), where the audio_id is an identifier for an audio file and normalize_volume is a Boolean value used to indicate whether to normalize the volume before playback (and subsequently restore the volume setting after playback). This is just one example of a function call to combine an audio playback command with a volume normalization command. It is understood that other types of signaling may be used to trigger the processes on the wagering game machine that playback audio or control output volume. Thus, according to an embodiment, the at least one volume command is incorporated with the command configured to cause each wagering game machine to play an audio file stored on the respective wagering game machine. In an alternative embodiment, the audio volume command is separate from the command that initiates playback of the audio file. In an embodiment, the audio volume command, either alone or in combination with the audio playback command, is incorporated with a command that initiates the shared game or is controlled at the same time as the initiation of the shared game.

The first and second commands can be individually addressed and communicated to each wagering game machine in a bank of wagering game machines. Thus, in an embodiment, the first and second commands are separate commands respectively addressed to the first and second wagering game machines. Alternatively, a broadcast command can be used to signal wagering game machines to begin audio playback at a certain time. Thus, in an embodiment, the first and second commands are encapsulated in a single command communicated to both of the first and second wagering game machines.

The methods described herein do not have to be executed in the order described, or in any particular order. In some embodiments, several of the activities described with respect to the methods may be left out. Moreover, various activities described with respect to the methods identified herein can be executed in repetitive, serial, or parallel fashion. The individual activities of the wagering game machine 100 and wagering game system 200 can also be combined with each other and/or substituted, one for another, in various ways to bring about the functionality described with respect to FIGS. 6-10. Information, including parameters, commands, operands, and other data, can be sent and received in the form of one or more carrier waves. Thus, many other embodiments may be realized.

### Example Embodiments

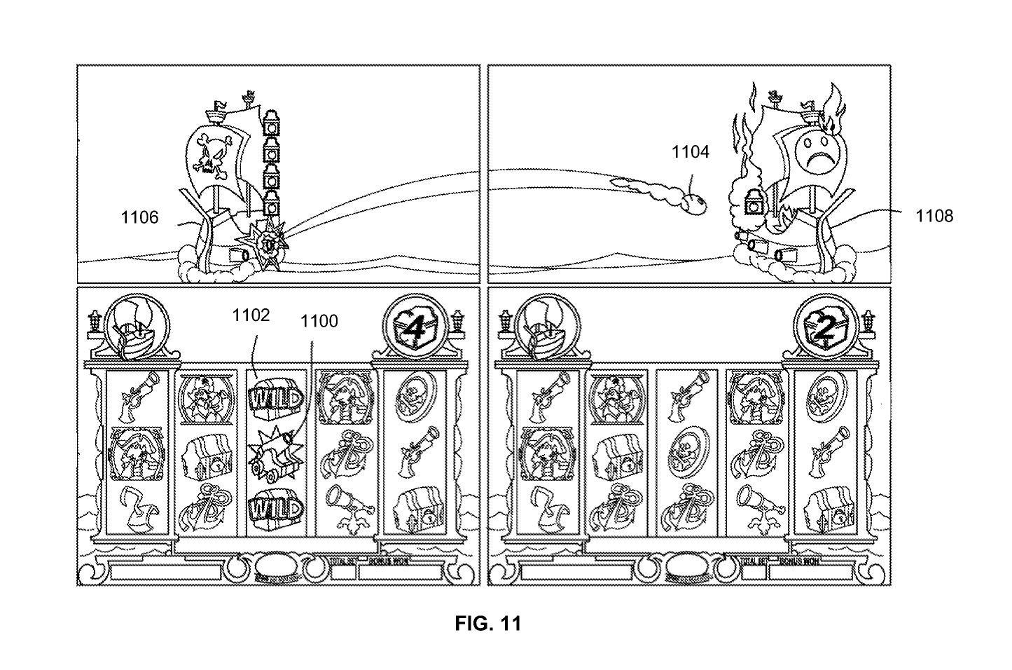

FIG. 11 is an image of a multi-display presentation, according to embodiments of the invention. FIG. 11 shows displays of wagering game machines arranged such as illustrated in FIG. 3. As illustrated in FIG. 11, a “CANNON” symbol 1100 has been achieved by a player on the bonus reel 1102 of a bonus game. The appearance of the CANNON symbol 1100 on one or more of the bonus reels triggers a “Pirate Battle” bonus game. It is contemplated that the Pirate Battle bonus game may be triggered in other ways, for example, at random intervals.

During the Pirate Battle bonus game, a cannonball 1104 launches from the pirate ship 1106 at a pirate ship 1108 of an opposing team. Hitting a pirate ship 1106, 1108 with a predetermined number of cannonballs 1104 causes the pirate ship 1106, 1108 to sink. The player who fired the cannonball that causes a pirate ship 1106, 1108 to sink then “steals” the treasure chests accumulated on the sunken ship. As an example, when a cannon ball is shot from the pirate ship 1106 at the pirate ship 1108, a whistling sound indicating the cannon ball's travel can be played through each of the wagering game machines in rapid succession to create a three-dimensional sound effect. In an embodiment, the wagering game machines volume settings are normalized before playing the cannon ball sound in order to further provide a consistent effect. As a further example, when a treasure chest is stolen, the chest may “fly” from the sunken ship to the pirate ship that sank the sunken ship to provide a visualization of the award. The movement of the treasure chest may be accompanied with an audio presentation panned across the respective wagering game machines.

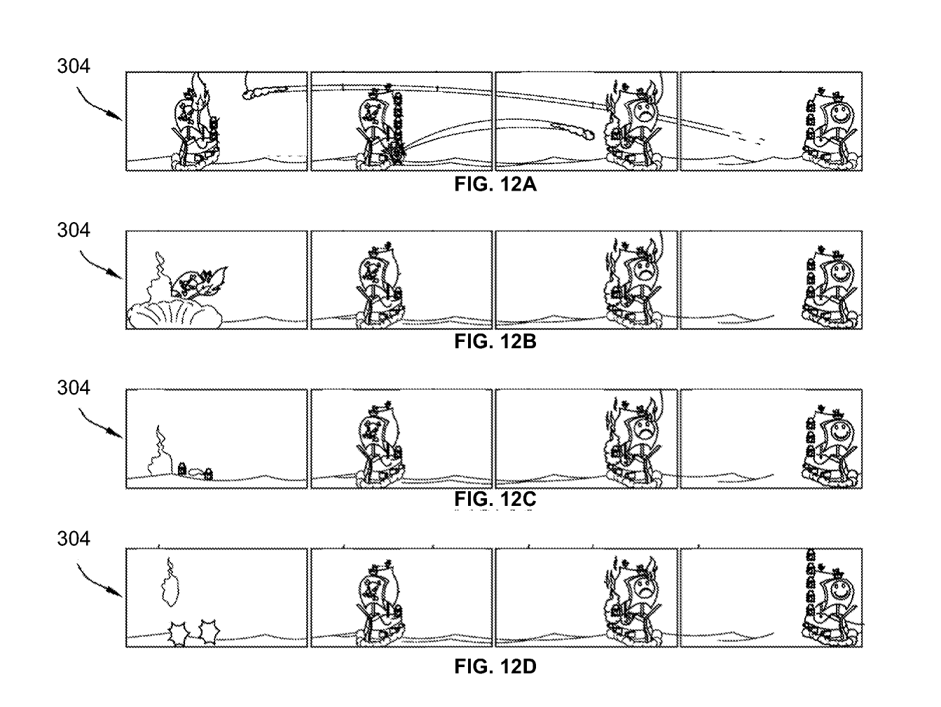

FIGS. 12A-12D are images of a multi-display presentation during an example game play, according to embodiments of the invention. Referring to FIGS. 12A-12D, for example, the shared secondary display 304 over the four gaming terminals 302A-D is shown. As discussed above, the shared secondary display 304 of the gaming terminals 302A-D is positioned generally adjacent to one another and function as a single, larger “metascreen.” Thus, an object (e.g., a cannonball 1104) is displayed as moving from a secondary display area of one gaming terminal 302A-D to the secondary display area of another gaming terminal 302A-D without losing continuity of the presentation.

### CONCLUSION

This Detailed Description is illustrative, and not restrictive. Many other embodiments will be apparent to those of ordinary skill in the art upon reviewing this disclosure. The scope of embodiments should therefore be determined with reference to the appended claims, along with the full scope of equivalents to which such claims are entitled.

In the Detailed Description, reference is made to specific examples by way of drawings and illustrations. These embodiments, which are also referred to herein as “examples,” are described in sufficient detail to enable those of ordinary skill in the art to practice the inventive subject matter, and serve to illustrate how the inventive subject matter may be applied to various purposes or embodiments. Other embodiments are included within the inventive subject matter, as logical, mechanical, electrical, and other changes may be made to the example embodiments described herein.

In this Detailed Description, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for choreographing an audio presentation among a plurality of wagering game machines, the wagering game machines initially being configured by respective users to play audio at respective user-selected volumes, each volume capable of being different from each other, the method comprising:
triggering a shared game among the plurality of wagering game machines; and
during the shared game, adjusting the plurality of wagering game machines to play audio at a specified common volume instead of the respective user-selected volumes.

2. The method of claim 1, further comprising at or after a conclusion of the shared game, adjusting the plurality of wagering game machines to play audio at the respective previously-configured user-selected volumes.

3. The method of claim 1, wherein each of the plurality of wagering game machines stores an audio file at the respective wagering game machine, and wherein the method further comprises:
choreographing the audio presentation among the plurality of wagering game machines by triggering play of the audio file at each of the respective wagering game machines.

4. The method of claim 1, further comprising presenting a visual presentation in coordination with the audio presentation.

5. The method of claim 4, wherein the visual presentation spans the plurality of wagering game machines and wherein the audio presentation tracks movement within the visual presentation.

6. The method of claim 1, wherein adjusting the plurality of wagering game machines to play audio at the specified common volume comprises issuing separate commands respectively addressed to each of the plurality of wagering game machines.

7. A wagering game apparatus for choreographing an audio presentation among a plurality of wagering game machines, each wagering game machine of the plurality of wagering game machines operable to be configured with a user-selected volume, the wagering game apparatus comprising:
one or more controllers configured to:
trigger a shared game among the plurality of wagering game machines; and
during the shared game, adjust the plurality of wagering game machines to play audio at a specified common volume instead of the respective user-selected volumes.

8. The wagering game apparatus of claim 7, wherein the one or more controllers are further configured to:
at or after a conclusion of the shared game, adjust the plurality of wagering game machines to play audio at the respective previously-configured user-selected volumes.

9. The wagering game apparatus of claim 7, wherein each of the plurality of wagering game machines stores an audio file at the respective wagering game machine, and wherein the one or more controllers are further configured to:
choreograph the audio presentation among the plurality of wagering game machines by triggering play of the audio file at each of the respective wagering game machines.

10. The wagering game apparatus of claim 7, wherein the one or more controllers are further configured to present a visual presentation in coordination with the audio presentation.

11. A method for choreographing an audio presentation among a plurality of wagering game machines, each of the wagering game machines capable of being played in an independent game mode and a shared game mode, the method comprising:
configuring the plurality of wagering game machines to operate in the independent game mode and while in the independent game mode allowing the wagering game machines to be configured by respective users to play audio at respective user-selected volumes, each user-selected volume configurable to be different from each other; and
configuring the plurality of wagering game machines to operate in the shared game mode and while in the shared game mode adjusting the plurality of wagering game machines to play audio at a specified game volume shared among the plurality of wagering game machines instead of the individual respective user-selected volumes.

12. The method of claim 11, further comprising in response to switching the plurality of wagering game machines back to the independent game mode from the shared game mode, adjusting the plurality of wagering game machines to play audio at the respective user-selected volumes.

13. The method of claim 11, wherein each of the plurality of wagering game machines is configured to store an audio file associated with the shared game mode at the respective wagering game machine, and wherein the method further comprises instructing each of the plurality of wagering game machines to play the respective audio file during the shared game mode.

14. The method of claim 11, further comprising displaying a visual presentation in coordination with the audio presentation.

15. The method of claim 14, wherein the visual presentation is presented in proximity to the plurality of wagering game machines and wherein the audio presentation tracks motion within the visual presentation.

16. A wagering game apparatus comprising:
a memory having an audio file stored therein;
an audio output mechanism configured to output audio with a volume in accordance with either of first and second operating modes, wherein the first operating mode comprises a user-definable volume level and the second operating mode comprises a pre-determined volume level; and
one or more controllers in operative communication with the audio output mechanism and configured to:
switch from one operating mode to the other in response to an externally supplied control signal;
receive an instruction to play the stored audio file; and
play the audio file from the memory through the audio output mechanism in response to the received instruction at the communication controller.

17. The wagering game apparatus of claim 16, wherein the externally-supplied control signal comprises the instruction to play the stored audio file.

18. The wagering game apparatus of claim 16, further comprising a second memory comprising instructions to perform the operations of the communication controller.

19. The wagering game apparatus of claim 16, wherein the memory having an audio file stored thereon further comprises instructions to perform the operations of the one or more controllers.

20. The wagering game apparatus of claim 16, wherein the one or more controllers includes a video controller configured to display a visual presentation in synchronicity with the played audio file.

21. A method for choreographing an audio presentation among a plurality of wagering game machines, at least one of the plurality of wagering game machines wagering game machine having a default volume setting and a user-defined volume setting, the method comprising:
receiving a command at a wagering game machine of a plurality of wagering game machines, the command received from a source external to the wagering game machine, and the command directing output of an audio file stored in the wagering game machine as part of the audio presentation;
setting a volume of the wagering game machine to the default volume setting before outputting the audio file;
outputting the audio file at the wagering game machine in choreographed relation to a visually observable presentation; and
returning the volume of the wagering game machine to the user-defined volume setting after outputting the audio file.

22. The method of claim 21, further comprising displaying the visually observable presentation on a display that is a part of the wagering game machine.

23. The method of claim 21, wherein the audio presentation and the visually observable presentation are incorporated into a wagering game.

24. The method of claim 23, wherein the wagering game is a multi-player wagering game.

25. The method of claim 21, wherein the command is received from a wagering game server.

26. A method for choreographing an audio presentation among a plurality of wagering game machines physically arranged in an organized manner and configured to participate in a shared wagering game, the method comprising:
displaying a visual presentation associated with the shared wagering game, the visual presentation spanning the plurality of wagering game machines; and
communicating a series of commands from a wagering game server to the plurality of wagering game machines, the series of commands to cause each of the wagering game machines of the plurality of wagering game machines to:
configure an output volume by changing the output volume from respective current established volume levels to a common predetermined volume level; and
play an audio file from a memory of a wagering game machine, the audio file associated with the shared wagering game.

27. The method of claim 26, further comprising configuring the output volume of each wagering game machine to return to the respective established volume level after the playing of the audio file.

28. The method of claim 26, further comprising configuring the output volume of each wagering game machine to return to the respective established volume level after completion of the shared wagering game.

29. A method for choreographing an audio presentation among a plurality of wagering game machines, the method comprising:
communicating a first command to a first wagering game machine of the plurality of wagering game machines, the first command configured to cause the first wagering game machine to play a first audio file stored on the first wagering game machine; and
communicating a second command to a second wagering game machine of the plurality of wagering game machines, the second command configured to cause the second wagering game machine to play a second audio file stored on the second wagering game machine, the playing of the second audio file in a predetermined relation to the playing of the first audio file.

30. The method of claim 29, further comprising communicating a third command to a third wagering game machine of the plurality of wagering game machines, the third command configured to cause the third wagering game machine to play a third audio file stored on the third wagering game machine, the playing of the third audio file occurring in a predetermined pattern in combination with the playing of the first and second audio files.

31. The method of claim 29, wherein the first and second audio files are played in association with a visual presentation.

32. The method of claim 29, wherein the first command is communicated from a wagering game server to the plurality of wagering game machines and wherein the first and second audio files are played in synchronicity with a visual presentation controlled by the wagering game server.

33. The method of claim 29, further comprising communicating at least one volume command to the plurality of wagering game machines, the at least one volume command configured to cause each of the wagering game machines to set an output volume to a default mode before outputting an audio file.

34. The method of claim 33, wherein the at least one volume command is incorporated with the command configured to cause each wagering game machine to play an audio file stored on the respective wagering game machine.

35. The method of claim 29, wherein the first and second commands are separate commands respectively addressed to the first and second wagering game machines.

36. The method of claim 29, wherein the first and second commands are encapsulated in a single command communicated to both of the first and second wagering game machines.
